(19) United States
(12) Patent Application Publication
(10) Pub. No.: US 2005/0277009 A1
(43) Pub. Date: Dec. 15, 2005

(54) Fuel cell separator and a method for manufacturing the same

(75) Inventors: Muneaki Mukuda, Tokyo (JP); Takayuki Inuzuka, Tokyo (JP); Akinari Minegishi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, TOKYO (JP)

(21) Appl. No.: 11/008,968

(22) Filed: Dec. 13, 2004

(30) Foreign Application Priority Data
Jun. 15, 2004 (JP) 2004-177033

(51) Int. Cl. H01M 8/02; B29B 13/00

(52) U.S. Cl. 429/34; 264/271.1

(57) ABSTRACT

A first resin is prepared which has a content of electrically conductive particles adjusted in the range from 60 wt % to 90 wt %, and a melt shear viscosity adjusted in the range from 1×10³ Pa.sec to 1×10⁷ Pa.sec. A second resin is prepared which has a content of electrically conductive particles that is adjusted in the range from 50 wt % to less than 90 wt % and that is less than that of the first resin. The second resin has a melt shear viscosity adjusted in the range from 1×10² Pa.sec to less than 1×10⁵ Pa.sec. A resin block prepared from the first resin is placed in a mold, and the second resin is injection molded into the mold while heating the mold to the melting temperature of the first resin or above.

### BACKGROUND OF THE INVENTION

1. Field of the Invention

The present invention relates to a fuel cell separator and a method for manufacturing the same, and more particularly, to such a fuel cell separator which is injection molded from a resin containing electrically conductive particles as well as to a manufacturing method therefor.

2. Description of the Related Art

A known fuel cell separator is constructed of a core layer part formed of a resin with a low carbon content and an outer layer part formed so as to cover an outer surface of the core layer part with a resin of a high carbon content (for example, see a first patent document: Japanese patent application laid-open No. 2000-323150). In the known separator as constructed in this manner, a high electrical conductivity is ensured in the outer layer part of a high carbon content, whereas physical strength is obtained in the core layer part of a low carbon content.

Two methods for manufacturing a fuel cell separator are described in the above-mentioned first patent document.

First of all, according to the first manufacturing method, a separator is produced by using a double layer forming technology in which a resin of a low carbon content is first injection molded into a mold of a desired shape, and thereafter a resin of a high carbon content is injection molded with the mold being opened to a slight extent. As a result, the separator is formed in such a manner that the resin of the high carbon content covers the resin layer of the small carbon content, and the boundaries between these resins are combined or joined to each other through compatibilization.

In addition, in the second manufacturing method, a resin, which has a high carbon content and a high flowability, is injection molded in a mold of a desired shape, and then a resin, which has a high carbon content and a low flowability, is injection molded in the mold before the high flow resin solidifies. Here, the flowability of the resin is adjusted by the molecular weight of each resin, so that the high flow resin sticks to the front surface of the mold, and the central portion or core of the high flow resin is replaced with the low flow resin. As a result, the separator is molded in such a manner that the resin having the low carbon content is covered with the resin having the high carbon content.

In the known first and second methods for manufacturing a fuel cell separator, the entire outer layer part, serving to ensure electrical conductivity, is formed by means of injection molding. Thus, injection molding the entire outer layer part increases the flow length for the resins upon injection molding, and also increases the content of the resins on the inner wall surface of the mold due to a tensile force, which acts on the flow front surface of an injected stream at its flow front, and a shearing stress, which is received by the resins at the flow front from the inner wall surface of the mold upon their movement toward the mold inner wall surface. In addition, carbon particles are oriented along the direction of flow of the resins thereby to form a skin layer.

Owing to the formation of such a skin layer, the electrical resistance of the outer layer part becomes high. Accordingly, if the carbon content of resin is increased so as to reduce the electrical resistance of the skin layer, the melt viscosity of the resin becomes large, so it becomes impossible to perform injection molding of the resin. Thus, in the known separator manufacturing methods, there has been a limitation to the reduction in the electrical resistance of the separator.

Moreover, the formation of such a skin layer precludes a uniform distribution of carbon particles over an area extending from a gate portion at which injection of resins is started up to the flow front of the resins, so it becomes impossible to obtain uniform electrical resistance over the entire outer layer part.

Further, the carbon content of the resin forming the core layer part is much lower than that of the resin forming the outer layer part which is limited to such a carbon content as to make it possible to perform injection molding. Therefore, the through electrical resistance in the thickness direction of the separator becomes high.

Since the two kinds of resins are injection molded with the single mold, an injection molding machine having two injection devices for these resins, respectively, is required, thus resulting in high production costs.

### SUMMARY OF THE INVENTION

Accordingly, the present invention is intended to obviate the problems as referred to above, and has for a first object to obtain a fuel cell separator and a manufacturing method therefor in which the separator of a low electrical resistance can be produced at low cost by placing in a mold a resin block made of a first resin having a high content of electrically conductive particles, and injection molding a second resin containing electrically conductive particles into the mold after the mold has been heated to a temperature equal to or higher than the melting temperature of the first resin.

Another object of the present invention is to obtain a method for manufacturing a fuel cell separator which is inexpensive and has a low electrical resistance by injection molding a resin containing electrically conductive particles into a mold after electrically conductive particles have been coated on the inner wall surface of the mold.

Bearing the above objects in mind, according to the present invention, there is provided a method for manufacturing a fuel cell separator in which an outer layer part is formed to cover an outer surface of a core layer part, the method including the steps of: adjusting a first resin that contains a first proportion of electrically conductive particles and a second resin that contains a second proportion of electrically conductive particles less than the first proportion; placing a resin block prepared from the first resin in a cavity of a mold; and injection molding the second resin into the cavity while heating the mold to a temperature equal to or higher than the melting temperature of the first resin.

According to the present invention, the resin block comprising the first resin is placed in the cavity. As a result, the content of the electrically conductive particles of the first resin can be increased, and hence it is possible to produce a separator with its outer layer part of a low electrical resistance. In addition, the flow length of the first resin becomes short, so the orientation of electrically conductive particles in the skin layer can be reduced. This also serves to provide a separator that has its outer layer part of a low electrical resistance. Moreover, since only the second resin is injection molded, only the flowability of the second resin can be reduced to an injectionable flowability level in consideration of a pressure loss in the gate. Consequently, it is possible to produce a separator that has its core layer part of an accordingly lowered electric resistance.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a cross sectional view schematically illustrating a single cell that constitutes a solid polymer type fuel cell according to a first embodiment of the present invention.

FIG. 2 is a cross sectional view showing a mold for injection molding a separator according to the first embodiment of the present invention.

FIGS. 3A through 3C are cross sectional views illustrating the processes or steps of manufacturing the separator according to the first embodiment of the present invention.

FIG. 4 is a view showing the results of evaluation of examples of the separator according to the first embodiment of the present invention.

FIG. 5 is a cross sectional view illustrating a process or step of forming an outer layer part in a separator manufacturing method according to a second embodiment of the present invention.

FIG. 6 is a cross sectional view illustrating a process or step of forming a core layer part in the separator manufacturing method according to the second embodiment of the present invention.

### DESCRIPTION OF THE PREFERRED EMBODIMENTS

Hereinafter, preferred embodiments of the present invention will be described in detail while referring to the accompanying drawings.

### Embodiment 1

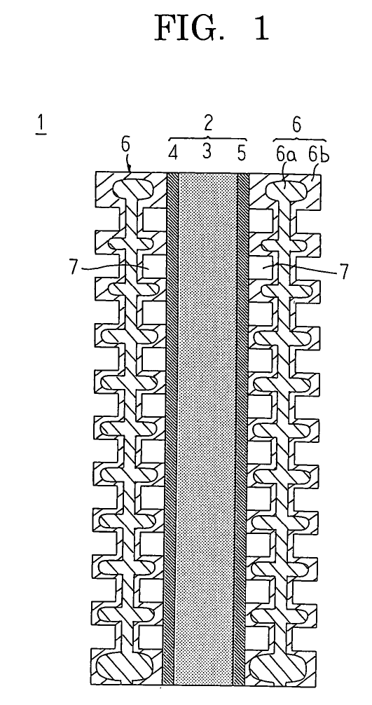

FIG. 1 is a cross sectional view that schematically illustrates a single cell constituting a solid polymer type fuel cell according to a first embodiment of the present invention.

In FIG. 1, the single cell, generally designated at reference numeral 1, includes a combined electrode and membrane member 2, and a pair of separators 6 arranged so as to clamp or sandwich the combined electrode and membrane member 2 from its opposite sides.

The combined electrode and membrane member 2 includes a pair of porous electrodes 4, 5 and an electrolyte membrane 3, and is arranged in such a manner that the porous electrodes 4, 5 each of a rectangular and planar configuration respectively face the opposite sides of the electrolyte membrane 3 of a similarly rectangular and planar configuration so as to be integrally combined therewith. The porous electrodes 4, 5 are formed of a porous medium such as carbon paper, carbon cloth, etc., and are each formed into a rectangular shape of outer dimensions equivalent to those of the electrolyte membrane 3, and have their surfaces, which are in contact with the electrolyte membrane 3, coated with a catalyst (not shown) that contains platinum as its principal component.

For the electrolyte membrane 3, there is used a solid polymer electrolyte membrane such as, for example, Nafion ( a registered trademark of Du Pond ), Aciplex ( a registered trademark of Asahi Chemical Industry Co., Ltd.), Flemion ( a registered trademark of Asahi Glass Company, Ltd.), etc.

The separators 6 are each formed into a rectangular shape of outer dimensions equivalent to those of the combined electrode and film member 2, and they have gas passages 7 formed on their opposite side surfaces including those which are in contact with the porous electrodes 4, 5.

Each of the separators 6 is prepared or made of a first resin and a second resin having different contents of electrically conductive particles, and includes a core layer part 6a and an outer layer part 6b that is formed so as to cover the outer surface of the core layer part 6a. Also, the outer layer part 6b is prepared or made of the first resin having a high content of electrically conductive particles, and serves to ensure the electrical conductivity of a corresponding separator 6, whereas the core layer part 6a is prepared or made of the second resin having a low content of electrically conductive particles, and serves to ensure the physical strength of a corresponding separator 6.

Here, the gas passages 7 are formed on the opposite sides of each separator 6, so that a plurality of combined electrode and membrane members 2 and separators 6 can be alternately stacked or laminated one over another to form a solid polymer type fuel cell. In addition, in cases where gas passages 7 are formed only at one side of each separator 6, a predetermined number of single cell elements, each of which is formed by sandwiching one combined electrode and membrane member 2 with a pair of separators 6, are stacked or laminated one over another to form a solid polymer type fuel cell.

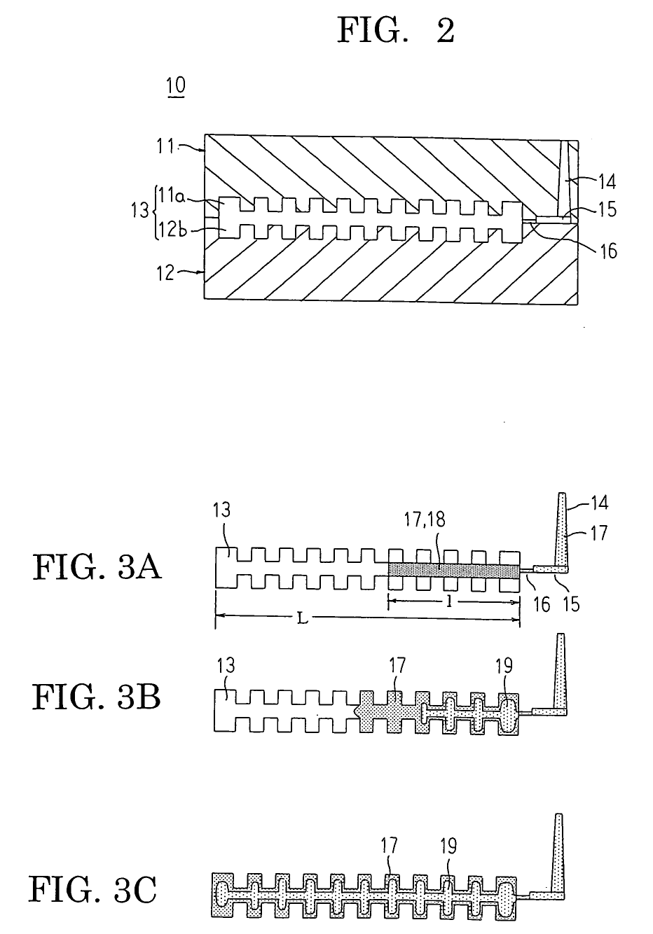

Next, reference will be made to a method for manufacturing a separator 6 while referring to FIG. 2 and FIG. 3. FIG. 2 is a cross sectional view that illustrates the mold for injection molding a separator according to the first embodiment of the present invention. FIGS. 3A through 3C are cross sectional views that illustrate the processes or steps of manufacturing a separator according to the first embodiment of the present invention.

In FIG. 2, the mold 10 is composed of an upper mold 11 and a lower mold 12, and the upper mold 11 is formed on its lower surface with first recessed grooves 11a that define the outer configuration of one side ( i.e., upper side ) of each separator 6, and the lower mold 12 is also formed on its upper surface with recessed grooves 12a that define the outer configuration of the other side ( i.e., lower side ) of each separator 6. The upper mold 11 and the lower mold 12 are assembled or combined with each other to provide the entire mold 10 with a cavity 13 being defined by the recessed grooves 11a, 12a. Moreover, a sprue 14, a runner 15 and a gate 16 are formed in the upper mold 11 so as to provide a path for injecting resin into the cavity 13.

First of all, by properly adjusting electrically conductive particles and a base resin, a first resin 17 is prepared in such a manner that the content of the electrically conductive particles is in the range from 60 weight percent (hereinafter referred to as wt %) (inclusive) to 90 wt % (inclusive), and the melt shear viscosity of the resin at a shear rate of 1,000 sec⁻¹ at the melting temperature thereof is in the range from 1×10³ Pa.sec (inclusive) to 1×10⁷ Pa.sec (inclusive). Also, by properly adjusting electrically conductive particles and a base resin, a second resin 19 is prepared in such a manner that the content of the electrically conductive particles is in the range from 50 wt % (inclusive) to 90 wt % (inclusive), and the melt shear viscosity of the resin at a shear rate of 1,000 sec⁻¹ at the melting temperature thereof is in the range from 1×10² Pa.sec (inclusive) to less than 1×10⁵ Pa.sec.

Subsequently, the first resin 17 is press molded to prepare a first resin block 18. This first resin block 18 is of a rectangular and planar configuration having substantially the same thickness as the minimum thickness or distance of a space in the cavity 13 ( i.e., thickness between the opposed bottoms of the gas passages 7 in a separator 6) as well as a longitudinal length equal to about 30-50% of the longitudinal length of the cavity 13 in the direction of flow of the resin (hereinafter also referred to as the resin flow direction length).

Thereafter, the resin block 18 is placed in the recessed grooves 12a i.e., the upper surface) of the lower mold 12 in a manner as to contact an outlet of the gate 16, and the upper mold 11 is set onto the lower mold 12. Then, the mold 10 thus formed or set is heated to a temperature equal to or higher than the melting temperature of the first resin 17 (base resin) to cause the resin block 18 to melt, after which the second resin 19 is injection molded into the cavity 13 through the sprue 14, the runner 15 and the gate 16, as shown in FIG. 3A.

When the second resin 19 is poured or injected into the cavity 13, it flows into the core layer part of the first resin 17. Owing to the pressure of the second resin 19, there is generated a shear flow, the speed of which becomes the greatest at the thicknesswise center of the cavity 13 and zero on the surface thereof, so that the first resin 17 is caused to deform in such a manner as to be swept away to the surface of the cavity 13, as shown in FIG. 3B, and the second resin 19 advances while flowing in the core layer part of the first resin 17. As a result, the first resin 17 is swept away to the forward direction of the second resin 19 while being filled into the upper and lower grooves of the cavity 13.

Thus, the cavity 13 is filled with the first and second resins 17, 19, as shown in FIG. 3C, whereby the outer layer part 6b formed of the first resin 17 covers the outer surface of the core layer part 6a formed of the second resin 19, thereby providing a separator 6 in which boundaries between the first and second resins 17, 19 are compatibilized to be integrally combined with each other.

Here, note that carbon particles on the order of submicrometers, carbon particles on the order of submillimeters, carbon short fibers on the order of submicrometers or the like can be used as the electrically conductive particles. In this regard, the through electrical resistance of the separators 6 after injection molding can be reduced by using carbon particles (including carbon microparticles). Further, by the use of carbon fibers, the electric resistance of the separators 6 can be reduced with a small content thereof.

For the base resin used for the first and second resins, there can be used at least one resin chosen from polyphenylene sulfide resin, polyarylate resin, polysulfone resin, polyethersulfone resin, polyphenylene ether resin, polyetherether ketone resin, polyolefin resin, polyester resin, polycarbonate resin, polystyrene resin, acrylic resin, polyamide resin, fluorocarbon resin, and liquid crystal polymer.

When the ratio {(I/L)×100} of a length I of the resin block 18 from the outlet of the gate 16 to an end thereof in the direction of flow of the resin to a length L of the cavity 13 from the outlet of the gate 16 to an end thereof in the direction of flow of the resin is smaller than 30%, the amount of the first resin 17 is too small, so only the second resin 19 is filled into the cavity 13 at the end thereof in the direction of flow of the resin. On the other hand, when the above ratio exceeds 50%, the amount of the first resin 17 is too large, so only the first resin 17 is filled into the cavity 13 at the end thereof in the direction of flow of the resin. Accordingly, it is preferable that the length l of the resin block 18 in the direction of flow of the resin, which is arranged in contact with the outlet of the gate 16, be in the range from 30% (inclusive) to 50% (inclusive) of the length L of the cavity 13 from the outlet of the gate 16 to the end thereof in the direction of flow of the resin.

In addition, the resin block 18 may be formed by injection molding instead of press molding. In this case, since high precision is not required of the outer configuration of the resin block 18, the first resin 17 can be injection molded by increasing the diameter of the gate 16 thereby to reduce the injection moldable flowability of the resin.

Moreover, in order to melt the first resin 17, the temperature of the mold 10 is raised up to a temperature equal to or higher than the melting temperature (melting point) of the first resin 17 before the injection molding of the second resin 19. Here, it is preferable from the point of view of shortening the molding cycle that the temperature of the mold 10 at this time be in the temperature range from the melting point of the first resin 17 (inclusive) to a temperature of 50° C. higher than that melting point.

When the content of the electrically conductive particles in the first resin 17 is less than 60 wt %, the electric resistance of the outer layer part 6b becomes high, so it becomes impossible to ensure the desired electrical conductivity of the separators 6. On the other hand, when the content of the electrically conductive particles in the first resin 17 exceeds 90 wt %, the flowability of the first resin 17 becomes too low, so it becomes difficult for the first resin 17 to be swept away forward in the direction of flow of the resin due to the pressure of the second resin 19 that is advancing while flowing in the core layer part of the first resin 17. As a result, the second resin 19 penetrates through the first resin 17, and an end portion of the cavity 13 in the direction of flow of the resin is filled with the second resin 19 alone. Accordingly, it is preferable that the content of the electrically conductive particles in the first resin 17 be in the range from 60 wt % (inclusive) to 90 wt % (inclusive), and more preferably in the range from 70 wt % (inclusive) to 90 wt % (inclusive).

Further, when the melt shear viscosity of the first resin 17 at a shear rate of 1,000 sec⁻¹ at the melting temperature thereof is less than 1×10³ Pa.sec, the flowability of the first resin 17 becomes too high, so a shear flow generated by the pressure of the second resin 19 being injection molded is reduced, thus making it impossible for the second resin 19 to flow through the core layer part of the first resin 17 to reach the end thereof in the direction of flow of the resin. That is, only the first resin 17 is filled into the end portion of the cavity 13 in the direction of flow of the resin. On the other hand, the melt shear viscosity of the first resin 17 at a shear rate of 1,000 sec⁻¹ at the melting temperature thereof is larger than 1×10⁷ Pa.sec, the flowability of the first resin 17 becomes too low, so the second resin 19 penetrates through the first resin 17, and the end portion of the cavity 13 in the direction of flow of the resin is filled with the second resin 19 alone. Accordingly, it is preferable that the melt shear viscosity of the first resin 17 at the shear rate of 1,000 sec⁻¹ at the melting temperature thereof be in the range from 1×10³ Pa.sec (inclusive) to 1×10⁷ Pa.sec (inclusive).

When the content of the electrically conductive particles in the first resin 19 is less than 50 wt %, the electric resistance of the core layer part 6a becomes high, so it becomes impossible to ensure the desired electric resistance of the separators 6. In addition, when the content of the electrically conductive particles is 90 wt % or higher, the amount of the base resin decreases too much, so the desired physical strength of each separator 6 can not be obtained. Accordingly, it is preferable that the content of the electrically conductive particles in the second resin 19 be in the range from 50 wt % (inclusive) to less than 90 wt %.

Further, when the melt shear viscosity of the second resin 19 at a shear rate of 1,000 sec⁻¹ at the melting temperature thereof is less than 1×10² Pa.sec, the flowability of the second resin 19 becomes too high, so the second resin 19 being injection molded penetrates through the core layer part of the first resin 17, and the end portion of the cavity 13 in the direction of flow of the resin is filled with the second resin 19 alone. On the other hand, the melt shear viscosity of the second resin 19 at the shear rate of 1,000 sec⁻¹ at the melting temperature thereof is equal to or larger than 1×10⁵ Pa.sec, the flowability of the second resin 19 becomes too low, so the second resin 19 can not be injection molded from the gate 16. Accordingly, it is preferable that the melt shear viscosity of the second resin 19 at the shear rate of 1,000 sec⁻¹ at the melting temperature thereof be in the range from 1×10² Pa.sec (inclusive) to less than 1×10⁵ Pa.sec.

Here, note that the melt shear viscosities of the first and second resins 17, 19 at the shear rate of 1,000 sec⁻¹ at the respective melting temperatures thereof were measured by using, as a viscosity measuring instrument, Capillograph 1D made of Toyo Seiki Co., Ltd., with a capillary length of 10 mm and a capillary diameter of 1 mm.

In the separators 6 according to the first embodiment, the outer layer part 6b is prepared from the first resin 17 which is adjusted such that the content of the electrically conductive particles is in the range from 60 wt % (inclusive) to 90 wt % (inclusive), and the melt shear viscosity of the resin at a shear rate of 1,000 sec⁻¹ at the melting temperature thereof is in the range from 1×10³ Pa.sec (inclusive) to 1×10⁷ Pa.sec (inclusive). Therefore, the electric resistance of the outer layer part 6b is made low so that the electrical conductivity of the separators 6 can be ensured.

Also, the core layer part 6a is prepared from the second resin 19 which is adjusted such that the content of the electrically conductive particles is in the range from 50 wt % (inclusive) to less than 90 wt % and at the same time is less than the content of the electrically conductive particles of the first resin 17, and that the melt shear viscosity of the resin at a shear rate of 1,000 sec⁻¹ at the melting temperature thereof is in the range from 1×10² Pa.sec (inclusive) to less than 1×10⁵ Pa.sec. Thus, the physical strength of the separators 6 is ensured, and at the same time the through electrical resistance in the thickness direction of the separators 6 can be reduced.

In the manufacturing method for the separators 6 according to the first embodiment, the resin block 18 formed of the first resin 17 constituting the outer layer part 6b is beforehand placed in the cavity 13 of the mold 10, that is, the first resin 17 is not injection molded into the cavity 13 through the gate 16. Therefore, it is not necessary to reduce the flowability of the first resin 17 to an injection moldable flowability level in consideration of a pressure loss in the gate 16 of the mold 10 at the time of molding. Accordingly, the content of the electrically conductive particles of the first resin 17 can be increased so that the electric resistance of the outer layer part 6b can be made low.

In addition, the resin block 18 is arranged in the cavity 13 in a manner as to extend from the outlet of the gate 16 to a range of 30%-50% of the length L of the cavity 13 in the direction of the resin flow. Therefore, the flow length of the first resin 17 at the time of injection molding of the second resin 19 can be shortened substantially by half in comparison with the case in which the first resin 17 is injection molded. Accordingly, the orientation of the carbon particles in the skin layer due to the shear flow of the first resin 17 can be reduced, and hence an increase in the electric resistance of the outer layer part 6b can be suppressed. Moreover, the distribution of the electrically conductive particles from the outlet of the gate 16 to the end of the cavity 13 in the direction of the resin flow can be made uniform, thus making it possible to provide a uniform electric resistance over the outer layer part 6b as a whole.

Further, since the injection molding of the first resin 17 is not needed, what is injection molded becomes only the second resin 19. Accordingly, the resins to be injection molded become one kind (i.e., the second resin 19), and hence there is no need to use any special molding machine, thereby making it possible to suppress the production costs of the separators 6. Furthermore, only the flowability of the second resin 19 can be reduced up to an injection moldable flowability level in consideration of the pressure loss in the gate 16. As a result, the carbon content of the second resin 19 can be adjusted to 50 wt % or higher, so the electric resistance of the core layer part 6a can be made low, and hence, the through electrical resistance in the thickness direction of the separators 6 can be reduced.

Hereunder, reference will be made in more detail to examples according to the first embodiment of the present invention.

### EXAMPLE 1

In this first example, polyphenylene sulfide resin was used as a base resin, and carbon particles were used as electrically conductive particles. Carbon particles were added to the polyphenylene sulfide resin at 70 wt % so that a first resin was prepared and adjusted so as to have a melt shear viscosity of 2×10⁶ Pa.sec at a resin temperature of 290° C. at a shear rate of 1,000 sec⁻¹. In addition, carbon particles were added to the polyphenylene sulfide resin at 65 wt % so that a second resin was prepared and adjusted so as to have a melt shear viscosity of 5×10³ Pa.sec at a resin temperature of 290° C. at a shear rate of 1,000 sec⁻¹.

Subsequently, the first resin thus prepared was press molded to provide a resin block. The resin block was constructed to be of a rectangular and planar configuration having substantially the same thickness as the minimum thickness or distance of a space or cavity in a mold (i.e., thickness between opposed bottoms of gas passages in a separator) as well as a longitudinal length equal to 40% of the longitudinal length of the cavity in a resin flow direction.

Thereafter, the resin block was placed in recessed grooves (i.e., an upper surface) of a lower mold in a manner as to contact an outlet of a gate, and an upper mold was set onto the lower mold. Then, the entire mold was heated to 300° C. (the melting temperature of the polyphenylene sulfide resin being 280-290° C.) so that the resin block was melted, after which the second resin was injection molded into the cavity in the mold through a sprue, a runner and the gate formed therein.

Thereafter, the mold was cooled to room temperature, and a separator was obtained.

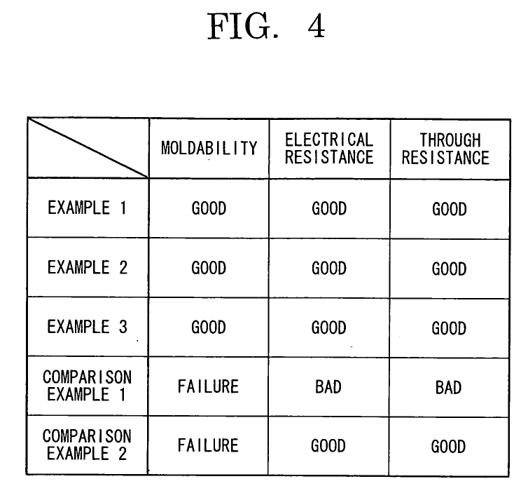

The results of evaluation on the moldability and electrical property of the separator thus obtained are shown in FIG. 4.

The moldability of the separator was evaluated by cutting the separator and observing the cross section thereof thus formed. As the result of such evaluation, it was verified that a core layer part was formed up to every corner of the separator and covered with an outer layer part without being exposed therefrom, thus providing excellent moldability. Besides, the separator thus obtained exhibited an excellent electrical resistance value and an excellent through electrical resistance value.

### EXAMPLE 2

In this second example, polyphenylene sulfide resin was used as a base resin, and carbon particles were used as electrically conductive particles. Carbon particles were added to the polyphenylene sulfide resin at 60 wt % so that a first resin was prepared and adjusted so as to have a melt shear viscosity of 5×10³ Pa.sec at a resin temperature of 290° C. at a shear rate of 1,000 sec⁻¹. In addition, carbon particles were added to the polyphenylene sulfide resin at 50 wt % so that a second resin was prepared and adjusted so as to have a melt shear viscosity of 3×10² Pa.sec at a resin temperature of 290° C. at a shear rate of 1,000 sec⁻¹.

Subsequently, the first resin thus prepared was press molded to provide a resin block. The resin block was constructed to be of a rectangular and planar configuration having substantially the same thickness as the minimum thickness or distance of a space or cavity in a mold (i.e., thickness between opposed bottoms of gas passages in a separator) as well as a longitudinal length equal to 30% of the longitudinal length of the cavity in a resin flow direction.

Thereafter, a separator was molded in a manner similar to the first example.

The results of evaluation on the moldability and electrical property of the separator thus obtained are shown in FIG. 4.

In this second example, too, similar to the first example, the separator having an excellent electrical resistance value and an excellent through electrical resistance value was obtained without exposing a core layer part.

### EXAMPLE 3

In this third example, polyphenylene sulfide resin was used as a base resin, and carbon particles were used as electrically conductive particles. Carbon particles were added to the polyphenylene sulfide resin at 90 wt % so that a first resin was prepared and adjusted so as to have a melt shear viscosity of 5×10⁶ Pa.sec at a resin temperature of 290° C. at a shear rate of 1,000 sec⁻¹. In addition, carbon particles were added to the polyphenylene sulfide resin at 80 wt % so that a second resin was prepared and adjusted so as to have a melt shear viscosity of 3×10⁴ Pa.sec at a resin temperature of 290° C. at a shear rate of 1,000 sec⁻¹.

Subsequently, the first resin thus prepared was press molded to provide a resin block. The resin block was constructed to be of a rectangular and planar configuration having substantially the same thickness as the minimum thickness or distance of a space or cavity in a mold (i.e., thickness between opposed bottoms of gas passages in a separator) as well as a longitudinal length equal to 50% of the longitudinal length of the cavity in a resin flow direction.

Thereafter, a separator was molded in a manner similar to the first example.

The results of evaluation on the moldability and electrical property of the separator thus obtained are shown in FIG. 4.

In this third example, too, similar to the first example, the separator having an excellent electrical resistance value and an excellent through electrical resistance value was obtained without exposing a core layer part.

### COMPARISON EXAMPLE 1

In this first comparison example, polyphenylene sulfide resin was used as a base resin, and carbon particles were used as electrically conductive particles. Carbon particles were added to the polyphenylene sulfide resin at 50 wt % so that a first resin was prepared and adjusted so as to have a melt shear viscosity of 5×10² Pa.sec at a resin temperature of 290 ° C. at a shear rate of 1,000 sec⁻¹. In addition, carbon particles were added to the polyphenylene sulfide resin at 40 wt % so that a second resin was prepared and adjusted so as to have a melt shear viscosity of 5×10¹ Pa.sec at a resin temperature of 290° C. at a shear rate of 1,000 sec⁻¹.

Subsequently, the first resin thus prepared was press molded to provide a resin block. The resin block was constructed to be of a rectangular and planar configuration having substantially the same thickness as the minimum thickness or distance of a space or cavity in a mold (i.e., thickness between opposed bottoms of gas passages in a separator) as well as a longitudinal length equal to 40% of the longitudinal length of the cavity in a resin flow direction.

Thereafter, a separator was molded in a manner similar to the first example.

The results of evaluation on the moldability and electrical property of the separator thus obtained are shown in FIG. 4.

Although exposure of a core layer part was not verified in this first comparison example, the wall thickness of an outer layer part in its end portion in the direction of the resin flow was extremely thin. This is considered due to the fact that the melt shear viscosities of the first and second resins were both too small, so the shear flow generated by the resin pressure of the second resin become accordingly small.

Moreover, the electrical resistance value and the through electrical resistance value of the separator were high, and it was impossible to achieve low resistances required for the separator. This is considered to result from the fact that the carbon contents in the first and second resins were both small.

### COMPARISON EXAMPLE 2

In this second comparison example, polyphenylene sulfide resin was used as a base resin, and carbon particles were used as electrically conductive particles. Carbon particles were added to the polyphenylene sulfide resin at 70 wt % so that a first resin was prepared and adjusted so as to have a melt shear viscosity of 2×10⁶ Pa.sec at a resin temperature of 290° C. at a shear rate of 1,000 sec⁻¹. In addition, carbon particles were added to the polyphenylene sulfide resin at 70 wt % so that a second resin was prepared and adjusted so as to have a melt shear viscosity of 5×10³ Pa.sec at a resin temperature of 290° C. at a shear rate of 1,000 sec⁻¹.

Subsequently, the first resin thus prepared was press molded to provide a resin block. The resin block was constructed to be of a rectangular and planar configuration having substantially the same thickness as the minimum thickness or distance of a space or cavity in a mold (i.e., thickness between opposed bottoms of gas passages in a separator) as well as a longitudinal length equal to 20% of the longitudinal length of the cavity in a resin flow direction.

Thereafter, a separator was molded in a manner similar to the first example.

The results of evaluation on the moldability and electrical property of the separator thus obtained are shown in FIG. 4.

Since in this second comparison example, the carbon contents in the first and second resins were in suitable ranges, respectively, the separator exhibited an excellent electrical resistance value and an excellent through electrical resistance value.

However, exposure of a core layer part in its end portion in the direction of the resin flow was verified. This is considered to result from the fact that the length in the resin flow direction of the resin block prepared from the first resin was short, and hence the amount of the first resin was accordingly insufficient.

### Embodiment 2

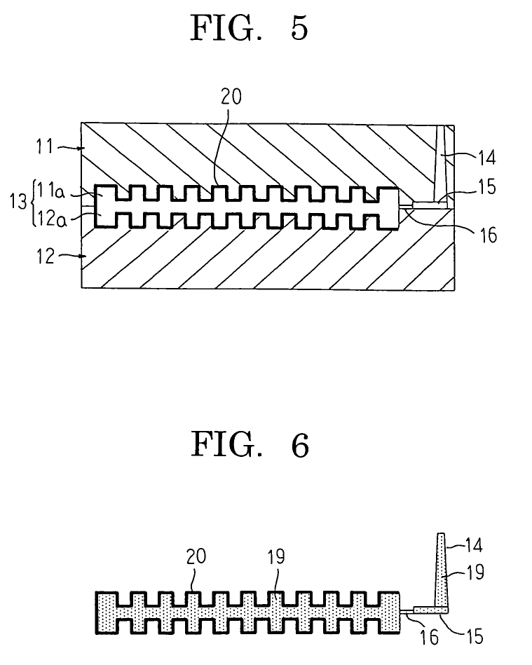

Now, a reference will be made to a separator manufacturing method according to a second embodiment of the present invention while referring to FIG. 5 and FIG. 6. FIG. 5 is a cross sectional view that illustrates a forming process or step for an outer layer part in the separator manufacturing method according to the second embodiment of the present invention. FIG. 6 is a cross sectional view that illustrates a forming process or step for a core layer part in the separator manufacturing method according to the second embodiment of the present invention.

First, carbon particles are coated on and attached to the surfaces of recessed grooves 11a, 12a of an upper mold 11 and a lower mold 12 by means of electrostatic coating, thereby forming a conductive particle layer in the form of a carbon particle layer 20. Then, as shown in FIG. 5, the upper mold 11 is set on the lower mold 12, and the mold 10 comprising the upper and lower molds 11, 12 is heated to a temperature equal to or higher than the melting temperature of a second resin 19, after which the second resin 19 is injection molded into a cavity 13 in the mold 10 through a sprue 14, a runner 15 and a gate 16 formed in the upper mold 11.

When the second resin 19 is poured or injected into the cavity 13, there is generated, due to the pressure of the second resin 19, a shear flow, the speed of which becomes the greatest at the thicknesswise center of the cavity 13 and zero on the surface thereof, and the second resin 19 advances while flowing in the cavity 13. Thus, the second resin 19 is filled into the cavity 13, as shown in FIG. 6. At this time, the carbon particle layer 20 is attached to the wall surface of the cavity 13 without being swept away by the second resin 19. Accordingly, there is obtained a separator in which the outer surface of the second resin 19 is covered with the carbon particle layer 20. Here, note that the carbon particle layer 20 constitutes an outer layer part, and the second resin 19 constitutes a core layer part.

In this second embodiment, too, since the carbon particle layer 20 constituting the outer layer part is beforehand formed through coating on the wall surface of the cavity 13 in the mold 10, the electric resistance of the outer layer part of the separator can be made low.

Further, since the injection molding of the outer layer part is not needed, what is injection molded becomes only the second resin 19. Accordingly, the resins to be injection molded become one kind (i.e., the second resin 19), and hence there is no need to use any special molding machine, thereby making it possible to suppress the production cost of the separator. Furthermore, only the flowability of the second resin 19 can be reduced up to an injection moldable flowability level in consideration of a pressure loss in the gate 16. As a result, the carbon content of the second resin 19 can be adjusted to 50 wt % or higher, so the electric resistance of the core layer part 6a can be made low, and hence, the through electrical resistance in the thickness direction of the separator can also be reduced.

In this second embodiment, prior to the injection molding of the second resin 19, carbon particles are coated on and attached to the wall surfaces of the recessed grooves 11a, 12a (i.e., cavity 13) of the upper and lower molds 11, 12 by means of electrostatic coating thereby to form the carbon particle layer 20. Instead of this, however, carbon particles are diluted in a solvent liquid such as alcohol, water, etc., and the liquid thus diluted may be coated on the wall surfaces of the recessed grooves 11a, 12a in the upper and lower molds 11, 12, after which the solvent is volatilized to attach the carbon particles to the wall surfaces of the recessed grooves 11a, 12a, thereby forming a carbon particle layer.

In addition, although in the above-mentioned respective embodiments, separators for use with a solid polymer type fuel cell have been described, they can be used for any type of fuel cell which is able to operate at a temperature equal to or lower than the melting point of resin employed.

Moreover, although carbon particles are used as electrically conductive particles in the above-mentioned respective embodiments, electrically conductive particles are not limited to carbon particles but instead any particles or like matters having electrical conductivity may be used for the same purpose. For example, metal powder or metal fiber can be used.

While the invention has been described in terms of preferred embodiments, those skilled in the art will recognize that the invention can be practiced with modifications within the spirit and scope of the appended claims.

1. A fuel cell separator in which an outer layer part is formed to cover an outer surface of a core layer part, said separator comprising:
said outer layer part being prepared from a first resin having a content of electrically conductive particles adjusted in the range from 60 wt % to 90 wt %, said first resin having a melt shear viscosity at a shear rate of 1,000 sec⁻¹ at the melting temperature thereof adjusted in the range from 1×10³ Pa.sec to 1×10⁷ Pa.sec; and
said core layer part being prepared from a second resin having a content of electrically conductive particles that is adjusted in the range from 50 wt % to less than 90 wt % and that is less than the content of the electrically conductive particles of said first resin, said second resin having a melt shear viscosity at a shear rate of 1,000 sec⁻¹ at the melting temperature thereof adjusted in the range from 1×10² Pa.sec to less than 1×10⁵ Pa.sec.

2. A method for manufacturing a fuel cell separator in which an outer layer part is formed to cover an outer surface of a core layer part, said method comprising the steps of:
adjusting a first resin that contains a first proportion of electrically conductive particles and a second resin that contains a second proportion of electrically conductive particles less than said first proportion;
placing a resin block prepared from said first resin in a cavity of a mold; and
injection molding said second resin into said cavity while heating said mold to a temperature equal to or higher than the melting temperature of said first resin.

3. The method for manufacturing a fuel cell separator as set forth in claim 2, wherein
said first resin is adjusted in such a manner that said first proportion is in the range from 60 wt % to 90 wt %, said first resin having a melt shear viscosity at a shear rate of 1,000 sec⁻¹ at the melting temperature thereof adjusted in the range from 1×10³ Pa.sec to 1×10⁷ Pa.sec; and
said second resin is adjusted in such a manner that said second proportion is in the range from 50 wt % to less than 90 wt % and is less than said first proportion, said second resin having a melt shear viscosity at a shear rate of 1,000 sec⁻¹ at the melting temperature thereof adjusted in the range from 1×10² Pa.sec to less than 1×10⁵ Pa.sec.

4. The method for manufacturing a fuel cell separator as set forth in claim 2, wherein said resin block is placed in intimate contact with a gate outlet in said cavity, and said resin block has a resin flow direction length that is in the range of from 30 % to 50 % of a resin flow direction length of said cavity.

5. The method for manufacturing a fuel cell separator as set forth in claim 4, wherein
said first resin is adjusted in such a manner that said first proportion is in the range from 60 wt % to 90 wt %, said first resin having a melt shear viscosity at a shear rate of 1,000 sec⁻¹ at the melting temperature thereof adjusted in the range from 1×10³ Pa.sec to 1×10⁷ Pa.sec; and
said second resin is adjusted in such a manner that said second proportion is in the range from 50 wt % to less than 90 wt % and is less than said first proportion, said second resin having a melt shear viscosity at a shear rate of 1,000 sec⁻¹ at the melting temperature thereof adjusted in the range from 1×10² Pa.sec to less than 1×10⁵ Pa.sec.

6. The method for manufacturing a fuel cell separator as set forth in claim 2, wherein said electrically conductive particles comprise carbon particles.

7. The method for manufacturing a fuel cell separator as set forth in claim 2, wherein said electrically conductive particles comprise carbon fibers.

8. A method for manufacturing a fuel cell separator in which a layer of electrically conductive particles is formed to over an outer surface of a core layer part, said method comprising the steps:
forming, through coating, said layer of electrically conductive particles on the entire wall surface of a cavity in a mold; and
injection molding a resin containing said electrically conductive particles into said cavity.

9. The method for manufacturing a fuel cell separator as set forth in claim 8, wherein said electrically conductive particles comprise carbon particles.

10. The method for manufacturing a fuel cell separator as set forth in claim 8, wherein said electrically conductive particles comprise carbon fibers.
